(19) United States
(12) Patent Application Publication
(10) Pub. No.: US 2021/0317794 A1
(43) Pub. Date: Oct. 14, 2021

(54) Method for Operating an Internal Combustion Engine, in Particular of a Motor Vehicle, in an Engine Braking Operation

(71) Applicant: Daimler AG, Stuttgart (DE)

(72) Inventors: Marc Oliver WAGNER, Esslingen am Neckar (DE); Thomas SCHUHMACHER, Stuttgart (DE)

(73) Assignee: Daimler AG, Stuttgart (DE)

(21) Appl. No.: 17/259,083

(22) PCT Filed: Jul. 4, 2019
(86) PCT No.: PCT/EP2019/067936

§ 371 Date: Jan. 8, 2021

(30) Foreign Application Priority Data
Jul. 10, 2018 (DE) 10 2018 005 457.9

(51) Int. Cl. F02D 13/04; F02D 13/02

(52) U.S. Cl. CPC F02D 13/04; F02D 13/0215

(57) ABSTRACT

A method for operating an internal combustion engine, in particular of a motor vehicle, in an engine braking operating, having at least one engine braking mode and having at least one cylinder at least of a first cylinder bank, where the at least one cylinder has at least one outlet valve and at least one inlet valve, where, in a first engine braking mode, an outlet stroke of all outlet valves of the at least one cylinder of the first cylinder bank of the internal combustion engine is permanently switched off.

BACKGROUND AND SUMMARY OF THE INVENTION

The invention relates to a method for operating an internal combustion engine, in particular of a motor vehicle, in an engine braking operation and a motor vehicle having an internal combustion engine and haying a control unit for carrying out a method.

A method for operating an internal combustion engine, in particular of a motor vehicle, in an engine braking operation, having at least one engine braking mode is already known. Typically, engine brakes are switched bank by bank, for example, in a 6-cylinder engine, the first, second and third cylinders of a first cylinder bank are switched together in the engine braking operation, and the fourth, fifth and sixth cylinders of a second cylinder bank are switched together in the engine braking operation, wherein the possibility emerges of implementing the engine braking operation only on the first three cylinders, only on the last three cylinders or on all cylinders. Similarly, the adjustable engine braking power is different depending on whether cylinders one to three, cylinders four to six or all cylinders are switched. Via an air pathway, such as an AGR valve, a wastegate, a throttle flap and/or an exhaust gas flap, for example, a specific engine braking torque strip can be adjusted within each of these engine braking steps which is spanned between the maximum possible and minimum possible braking torque. In particular when few actuators are present in the air pathway, such as one AGR valve and no wastegate, for example, the case arises in which the engine braking torque strips of a step do not overlap with the three cylinders in the engine braking operation and the step with all six cylinders in the engine braking operation, such that there are thus torques which cannot be expressed with either three or with six cylinders. Similarly, there is a region between the engine braking torque strip which can be expressed in propulsion, and the engine braking torque strip which can be expressed with three cylinders in the engine braking operation.

A method for operating an internal combustion engine in an engine braking operation having at least one engine braking mode is known from WO 2017/189626 A1. The internal combustion engine has at least one cylinder having at least one first cylinder bank, wherein the at least one cylinder has at least one outlet valve and at least one inlet valve. In the different engine braking modes, the outlet valves of two cylinder banks of the internal combustion engine can be operated in an engine braking mode and, here, the inlet valves are closed or, alternatively, are operated in a Miller or Atkinson method.

A method for operating an internal combustion engine in an engine braking mode having at least one engine braking mode is known from DE 10 2017 201 732 A1. The internal combustion engine has at least one cylinder, wherein the at least one cylinder has at least one outlet valve and at least one inlet valve. In the braking mode, the outlet strokes of the outlet valves are switched off The inlet valves are opened when a piston of the internal combustion engine is moved from an upper dead center towards a lower dead center.

In particular, the object of the invention is to provide an advantageously variable and efficient method for operating an internal combustion engine in an engine braking operation.

The invention is based on a method for operating an internal combustion engine, in particular of a motor vehicle, in an engine braking operation, having at least one engine braking mode, and having at least one cylinder at least of a first cylinder bank, wherein the at least one cylinder has at least one outlet valve and at least one inlet valve.

It is provided that, in a first engine braking mode, an outlet stroke of all outlet valves of the at least one cylinder of the first cylinder bank of the internal combustion engine is permanently switched off In each engine braking mode of the method, the outlet stroke of all outlet valves of at least one cylinder of the internal combustion engine is preferably permanently switched off. As a result of the inventive design of the method, a large region of the engine braking torque can advantageously be covered. Advantageously, a first engine braking mode is cost-effectively set up. An advantageous engine braking mode can be provided, in particular without additional actuators in the air pathway, such as turbochargers with variable turbine or compressor geometry, wastegates, or throttle flaps, for example. In particular, additional actuators in the air pathway, such as turbochargers with variable turbine or compressor geometry, wastegates or throttle flaps can be dispensed with. Furthermore, operating points, in particular, can be generated which close gaps between the known engine braking torque strips and the propulsion torque strip.

An “engine braking mode” is to be understood in this context, in particular, to mean a switchable mode of the internal combustion engine in which the internal combustion engine is switched into an engine braking mode. Preferably, a switchable mode of the internal combustion engine is to be understood by this m which the internal combustion engine is provided specifically for generating an engine braking torque. Preferably, in the engine braking mode, a compression function is used within the cylinder for the engine braking operation. Preferably, it is both conceivable that the engine braking mode is switched, in particular activated and/or deactivated, manually by an operator, and that the engine braking mode is switched at least partially automatically by a control and/or regulating unit. The engine braking mode differs from a normal operation in particular in that the internal combustion engine is operated without fuel injection and by the internal combustion engine being driven by the drive wheels of the motor vehicle. “An outlet stroke of all outlet valves is permanently switched off” is to be understood in this context in particular to mean that a stroke movement of the outlet valve(s) of the at least one cylinder is completely prevented at least for the majority of the duration of the first braking mode, in particular during the whole braking mode. Preferably, this is to be understood to mean that all the outlet valves of the at least one cylinder remain completely closed during the whole engine braking mode. “Provided” is to be understood in particular to mean specially programmed, designed and/or equipped. An object being provided for a certain function is to be understood, in particular, to mean that the object fulfils and/or carries out this specific function in at least one application and/or operating state.

In the first engine braking mode, an opening time point of all inlet valves of the at least one cylinder of the first cylinder bank is set to “late”. Preferably, the opening time point of all inlet valves of the at least one cylinder is set to “late” in such a way that a cylinder bank of the at least one cylinder enables an opening of the inlet valve(s), in particular all inlet valves, of the at least one cylinder. Thus, a large range of an engine braking mode can advantageously be covered. Preferably, with at least one engine braking mode, preferably with several engine braking modes, an advantageously large range of an engine braking torque can be covered. In particular, an advantageously even, in particular gapless, engine braking torque range can be provided. Furthermore, an engine operating mode can be set up advantageously cost-effectively. An adjustment of the opening time point to “late” is here to be understood, in particular, in relation to the crankshaft, particular in relation to a crank angle.

In the first engine braking mode, an inlet camshaft of the at least one cylinder of the first cylinder bank is adjusted to “late”. Preferably, an inlet camshaft of the at least one cylinder is adjusted to “late” in such a way that a cylinder pressure of the at least one cylinder enables an opening of all inlet valves, actuated by the inlet camshaft, of at least one cylinder. Thus, a large range of an engine braking moment can advantageously be covered. Preferably, with at least one engine braking mode, preferably with several engine braking modes, an advantageously large range of an engine braking torque can advantageously be covered. In particular, an advantageously even, in particular gapless, engine braking torque range can be provided. In particular for engine braking systems which already have a disconnection of the outlet valve stroke and a phase regulator on the inlet side, the method only involves low additional costs, such as in particular as a result of an additional electrical switching valve for separately switching off the outlet valve and switching on the engine brake, in particular on one of the two cylinder banks of the internal combustion engine. The torque ranges that cannot be achieved without the invention are advantageously at least partially also covered,

In the first engine braking mode, the outlet stroke of all outlet valves of all cylinders of the first cylinder bank of the internal combustion engine is switched off, and the opening time point of all inlet valves of the first cylinder bank is adjusted to “late”. Thus, in particular an advantageously even, in particular gapless, engine braking torque range can be provided. In particular for engine braking systems which already have a disconnection of the outlet valve stroke and a phase regulator on the inlet side, the method involves only low additional costs, such as in particular as a result of an additional electrical switching valve for separately switching off the outlet valve and switching on the engine brake on at least one cylinder bank of the internal combustion engine. Preferably, the internal combustion engine has at least two, preferably precisely two, cylinder banks. Each cylinder bank preferably comprises at least two, preferably three and particularly preferably exactly three cylinders. However, in principle, a different design of the internal combustion engine which seems reasonable to the person skilled in the art would also be conceivable.

In the first engine braking mode, all outlet valves of the cylinders of a second cylinder bank are closed for a first time, then opened for a first time, then closed for a second time and then opened for a second time in order to respectively release a gas compressed in the cylinder of the second cylinder bank from the cylinder of the second cylinder bank respectively by means of pistons guided in the cylinders of the second cylinder bank. The internal combustion engine has a second cylinder bank having at least one cylinder. By opening and closing all outlet valves of the second cylinder hank, in particular in combination with the preceding features, an advantageously high engine braking power can be achieved,

Alternatively, it is provided that, in the first engine braking mode, all outlet valves of all cylinders of a second cylinder bank are opened in the region of an upper dead center and then closed in order to respectively release a gas compressed in the cylinders of the second cylinder bank from the cylinders of the second cylinder bank respectively by means of pistons guided in the cylinders of the second cylinder bank. The internal combustion engine has a second cylinder bank having at least one cylinder. By opening and closing all outlet valves of the second cylinder bank, in particular in combination with the preceding features, an advantageously high engine braking power can be achieved.

In addition, it is provided that, in the first engine braking mode, an opening time point of all inlet valves of all cylinders of the second cylinder bank is set to “late”. Preferably, in the first engine braking mode, an outlet stroke of all outlet valves of the first cylinder bank of the internal combustion engine are additionally switched off and an opening time point of all inlet valves of the first cylinder is set to “late”. Thus, in particular an advantageously high engine braking power can furthermore be provided.

Furthermore, it is provided that, in a second engine braking mode, all cylinders of the second cylinder bank are operated in a tow operation. Preferably, in the second engine braking mode, an outlet stroke of all outlet valves of the first cylinder bank is additionally switched off and an opening time point of all inlet valves of the first cylinder bank is set to “late”. In doing so, in particular an advantageous engine braking power can be achieved which is smaller than the engine braking power in the first engine braking mode and, in particular, also smaller than the engine braking power normally provided with an cylinder bank and is thus suitable for closing the gap between propulsion operation and engine braking operation with a cylinder bank. The mass throughput needed for removing the heat generated is expressed on the second cylinder bank.

Furthermore, it is provided that, in a third engine braking mode, an outlet stroke of all outlet valves of all cylinders of the first and the second cylinder bank of the internal combustion engine is switched off and an opening time point of all inlet valves of all cylinders of the first and the second cylinder bank is set to “late”. Thus, in particular an advantageous engine braking power can be achieved, in particular, a decompression event towards the inlet side can be generated, whereby engine braking power is generated in turn. However, no mass throughout is generated by the engine, whereby the operating mode can only be maintained in the short term. Nevertheless, it is suitable for expressing a gentle transition from propulsion operation into engine braking operation or vice versa, which is always required for reasons of comfort, in particular for bus passengers. An advantageously high degree of comfort can be provided. In addition, with this operating point, e.g., by cyclical use, cooling down the exhaust gas after-treatment can be carried out by either no mass throughput or mass throughput with increased temperature being generated.

Furthermore, the invention is based on a motor vehicle having an internal combustion engine and having a control and/or regulating unit for carrying out the method. It is provided that the control and/or regulating unit be provided to carry out the method for controlling at least one camshaft regulator and/or at least the outlet valves of the internal combustion engine. Thus, in particular, a reliable operation of the internal combustion engine can be achieved. A “control and/or regulating unit” is to be understood, in particular, to mean a unit having at least one electronic control device. An electronic “control device” is to be understood, in particular, to mean a unit having a processor unit and having a storage unit and having an operating program saved in the storage unit. In principle, the control and/or regulating unit can have several control devices connected to one another which are preferably provided to communicate with one another via a Bus system, such as a CAN-Bus system, in particular. Depending on the further design, the control and/or regulating unit can additionally also have hydraulic and/or pneumatic components, such as valves in particular.

Further advantages emerge from the follow description of the Figures. An exemplary embodiment of the invention is depicted in the Figures. The Figures, the description of the Figures and the claims contain numerous features in combination. The person skilled in the art will also expediently consider the features in combination and combine them to form useful further combinations.

### BRIEF DESCRIPTION OF THE DRAWINGS

FIG. 1 is a schematic depiction of a motor vehicle having an internal combustion engine and having a multi-stage transmission in a schematic depiction;

FIG. 2 is a diagram of a valve elevation of valves of the cylinders of a second cylinder bank via a crank angle in a first engine braking mode for illustrating a method according to the invention for operating an internal combustion engine in an engine braking operating; and

FIG. 3 is a diagram of a valve elevation of valves of the cylinder of a first cylinder bank via a crank angle in a first engine braking mode for illustrating a method according to the invention for operating an internal combustion engine in an engine braking operating.

### DETAILED DESCRIPTION OF′FHE DRAWINGS

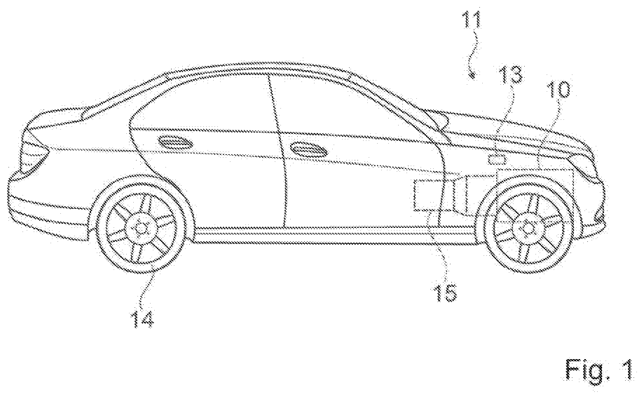

FIG. 1 schematically shows a motor vehicle 11. The motor vehicle 11 comprises a drivetrain via which drive wheels 14 of the motor vehicle H are operated in a manner that is not visible any further. The drivetrain comprises an internal combustion engine 10. The motor vehicle 11 has the internal combustion engine 10. The internal combustion engine 10 is formed from a combustion motor. Furthermore, the motor vehicle 11 has a multi-stage transmission 15. The internal combustion engine 10 has a driven crankshaft which is connected to a transmission input element of the multi-stage transmission 15. The multi-stage transmission 15 is formed from a motor vehicle transmission. The multi-stage transmission 15 forms a part of the drivetrain of the motor vehicle 11. The multi-stage transmission 15 is arranged behind the internal combustion engine 10 along the drivetrain, in particular along a flux of force of the drivetrain. The multi-stage transmission 15 is driven via the internal combustion engine 10 in at least one operating state.

The internal combustion engine 10 comprises at least one cylinder of a first cylinder bank and at least one cylinder of a second cylinder bank. In particular, the internal combustion engine 10 in total comprises six combustion chambers, for example, in the form of cylinders. The cylinders are arranged in a row, for example. A first, second and third cylinder are arranged in the first cylinder bank, wherein a fourth, fifth and sixth cylinder are arranged in the second cylinder bank. The cylinder banks each have a common exhaust gas manifold. A translationally moveable piston is respectively arranged in the cylinders. The pistons are flexibly coupled to a crankshaft of the internal combustion engine 10 via a respective conrod. The crankshaft is mounted on a crank housing of the internal combustion engine 10 rotatably around an axis of rotation relative to the crank housing. As a result of the flexible coupling of the pistons to the crankshaft, the translational movements of the pistons are converted into a rotational movement of the crankshaft around its axis of rotation. Furthermore, at least one inlet channel is respectively allocated to the cylinders, via which inlet channel air can flow into the respective cylinder. At least one inlet valve is respectively allocated to the inlet channel of the cylinders, which inlet valve can be moved between at least one closed position fluidically blocking the inlet channel of the respective cylinder and at least one open position fluidically releasing the inlet channel of the respective cylinder. Furthermore, at least one outlet channel is respectively allocated to the cylinders, via which outlet channel the exhaust gas can flow out of the respective cylinder. At least one outlet valve is allocated to the outlet channel of the respective cylinder, which outlet channel can be moved between a closed position fluidically blocking the outlet channel of the respective cylinder and at least one open position at least partially fluidically releasing the outlet channel of the respective cylinder. The inlet valves and the outlet valves are actuated, for example, respectively by means of an inlet camshaft and an outlet camshaft and thus respectively moved out of the respective closed position into the respective open position and, where necessary, held in the open position.

Furthermore, the motor vehicle 11 has a control and regulating unit 13 for carrying out a method for operating the internal combustion engine 10 of the motor vehicle 11 in an engine braking operation. The control and regulating unit 13 is provided to carry out the method for controlling camshaft actuators for adjusting the inlet camshaft in relation to the crankshaft and actuators for deactivating outlet valves or switching off outlet strokes as well as for activating engine braking strokes of the internal combustion engine 10. However, in principle it would also be conceivable for the control and regulating unit 13 to be provided for a direct control of outlet valves and inlet valves of a valve train of the internal combustion engine 10.

The method is provided for operating the internal combustion engine 10 of the motor vehicle 11, in an engine braking operation. The method has at least one engine braking mode. The method has several engine braking modes. The method has three engine braking modes. Here, the engine braking modes can be switched, re, in particular activated and/or deactivated, both manually by an operator and automatically by the control and/or regulating unit. Preferably, in addition to the engine braking modes described, a convention 3-cylinder engine braking operation or 6-cylinder engine braking operation can be switched.

With the method, an outlet stroke 12 of all outlet valves of at least one cylinder of the first cylinder bank of the internal combustion engine 10 is permanently switched off in a first engine braking mode.

With the method, the outlet stroke 12 of all outlet valves of at least one cylinder of the first cylinder bank of the internal combustion engine 10 is permanently switched off in each engine braking mode.

Furthermore, in the engine braking bodes, an opening time point EO1 of all inlet valves of the at least one cylinder of the first cylinder bank is adjusted to “late”. In the engine braking modes, an inlet camshaft of the at least one first cylinder of the first cylinder bank is adjusted to “late”. In the engine braking modes, an inlet camshaft of all cylinders of the first cylinder bank of the internal combustion engine 10 is adjusted to “late” The inlet camshaft of the first cylinder bank of the internal combustion engine 10 is here adjusted to “late” in such a way that a cylinder pressure of the at least one cylinder of the first cylinder bank enables an opening of the inlet valve of the first cylinder. With the method, in the engine braking modes, an outlet stroke 12 of all outlet valves of all cylinders of the first cylinder bank of the internal combustion engine 10 is thus switched off, and an opening time point EO1 of all inlet valves of all cylinders of the first cylinder bank is adjusted to “late”.

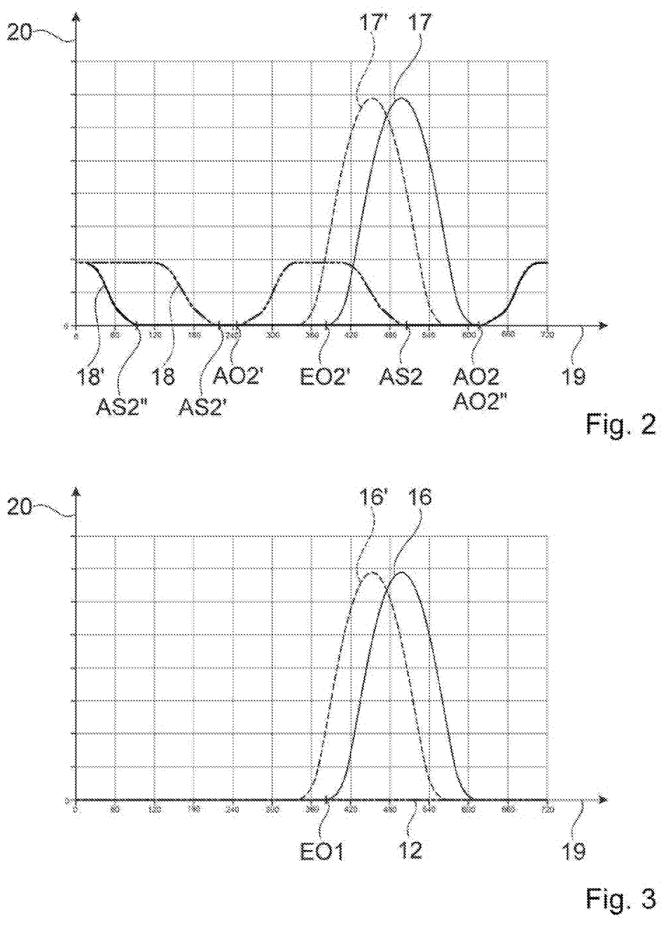

FIG. 3 shows a diagram of a valve elevation of valves of the cylinders of the first cylinder bank via a crank angle for illustrating the method for operating the internal combustion engine 10 in an engine braking mode. The crank angle here describes the respective depictions of the crankshaft around its axis of rotation. FIGS. 2 and 3 each show diagrams on the x-axis 19 of which the rotational positions, i.e., the degree crank angle of the crankshaft, is plotted. The internal combustion engine 10 is here formed as a four-stroke engine, wherein a. so-called work cycle of the crankshaft comprises exactly two rotations of the crankshaft. The work cycle comprises exactly 720° of crank angle. In contrast, an opening height of the valves is plotted on the y-axis 20. The higher the respective course, the wider the corresponding valve is opened with an allocated rotational position of the crankshaft. If the respective course is on the value “zero” plotted on the y-axis 20, then the respective valve is closed. The outlet stroke 12 of all outlet valves of all cylinders of the first cylinder bank here remains at “zero” for the entire work cycle. In contrast, an inlet stroke 16 of all inlet valves of all cylinders of the first cylinder bank is adjusted to “late” in comparison to a regular inlet stroke 16′. The inlet stroke 16 of the inlet valves of the first cylinder bank is adjusted to “late” by a 45° crank angle. However, in principle, a different adjustment angle that seems reasonable to the person skilled in the art would also be conceivable. In order to depict particularly low engine braking powers, the inlet stroke 16 is advantageously adjusted to late by a long way, wherein the maximum adjustment is limited by the inlet valves not coming into contact with the corresponding piston. Thus, on the first cylinder bank, a conventional outlet stroke 12 of all outlet valves of all cylinders is switched off, yet an engine braking stroke is not switched on and, at the same time, the inlet camshaft is adjusted via camshaft actuators so far to “late” that the cylinder pressure against which the inlet valves of the first cylinder bank open does not exceed the maximum cylinder pressure at which this is possible, for example at 20 bar. Preferably, all cylinders of the first cylinder bank, in particular respectively temporally offset, have the same valve elevations across the crank angle. An offset emerges, in particular, from an ignition sequence and from a number of cylinders. FIG. 3 shows a diagram of the valve elevation of valves of the first cylinder of the first cylinder bank across a crank angle by way of example in a first engine braking mode.

In the first engine braking mode, all outlet valves of all cylinders of a second cylinder bank are closed for a first time, then opened for a first time, and then closed for a second time and then opened for a second time, in order to respectively release gas compressed in the cylinders of the second cylinder bank respectively from the cylinder respectively by means of pistons guided in the cylinders of the second cylinder bank. As shown in FIG. 2, in the first engine braking mode of the method, all outlet valves of the cylinders of the second cylinder bank are closed for a first time, in particular offset in relation to one another, at a first closing time point AS2, then opened for a first time at a first open time point AO2, then closed for a second time at a second closing time point AS2′ and then closed for a second time at a. second opening time point AO2′, in order to release a gas contained in the cylinders of the second cylinder bank respectively from the cylinders respectively by means of pistons guided in the cylinders of the second cylinder bank. Along with the outlet strokes described, other outlets strokes that seem reasonable to the person skilled in the art are also conceivable, in particular a controller of the outlet valves with outlet valve strokes for a backward charging or outlet strokes for an engine brake functioning according to the two-stroke principle. Furthermore, in the first engine braking mode, an opening time point EO2′ of all inlet valves of the cylinders of the second cylinder bank is adjusted to “late”. An inlet stroke 17 of the inlet valves of the second cylinder bank is adjusted to “late” in relation to a regular inlet stroke 17′. The inlet stroke 17 of the inlet valves of the second cylinder bank is adjusted to “late” by 45° of crank angle. However, in principle, a different adjustment angle that seems reasonable to a person skilled in the art would also be conceivable.

For this, FIG. 2 shows a diagram of a valve elevation of valves of the cylinders of the second cylinder bank across a crank angle for illustrating the method for operating the internal combustion engine 10 in an engine braking mode. In the diagram, a course of the inlet stroke 17 is depicted which describes the movement, i.e., the opening and closing, of an inlet valve of the cylinder of the second cylinder hank. For the sake of clarity, only the course of an inlet valve of a cylinder of the second cylinder bank is depicted in the diagram. Furthermore, in the diagram, a course of an outlet stroke 18 is depicted, which describes the movement, i.e., the opening and closing, of all outlet valves of all cylinders of the second cylinder bank. For the sake of clarity, only the course of an outlet valve of a cylinder of the second cylinder bank is depicted in the diagram. Preferably, all cylinders of the second cylinder bank, in particular respectively offset temporally, have the same valve elevations across the crank angle. An offset emerges in particular from an ignition sequence and from a number of cylinders.

As can be seen by means of the course of the one outlet stroke 18, the outlet valves of the cylinders of the second cylinder bank are closed twice and opened twice within a work cycle of the cylinders or the allocated pistons. Based on the inlet stroke 17 of the inlet valves of the cylinders of the second cylinder bank, the outlet valves of the cylinders of the second cylinder bank are closed for a first time within the work cycle of the cylinders or the pistons at the first closed time point AS2 shortly after 480° of crank angle. This closed time point AS2 is in the region of the inlet stroke 17. Within the work cycle of the cylinders of the second cylinder bank, the outlet valves of the cylinders of the second cylinder bank are opened for a first time following the first closing at the first closing time point AS2 at the first opening time point AO2 shortly before 660° of crank angle. The outlet valves of the cylinders of the second cylinder bank are then closed for a second time at the second closing time point AS2′ shortly before 240° of crank angle. The outlet valves of the cylinders of the second cylinder bank are then opened for a second time at a second opening time point AO2′ shortly after 240° of crank angle. As a result of the first closing time point AS2 after closing the inlet valves, the fresh air in the cylinders of the second cylinder bank is compressed by means of the pistons. By means of the first opening at the first opening time point AO2 and the second closing at the second closing time point AS2′, the outlet valves carry out a first decompression stroke within the work cycle of the cylinders, such that the cylinders of the second cylinder bank each carry out a first decompression cycle. Here, by means of the first opening at the first opening time point AO2, the fresh air previously compressed by means of the piston or the gas previously compressed by the piston is released from the cylinders of the second cylinder bank via the outlet channels of the cylinders of the second cylinder bank without compression energy stored in the compressed gas being able to be used in order to move the piston from its upper dead center into its lower dead center. Since the internal combustion engine 10 previously had to work to compress the gas, this is accompanied by a braking of the internal combustion engine 10 and thus the motor vehicle. By means of the second opening at the second opening time point AO2′ and the first closing at the first closing time point AS2, the outlet valves of the cylinders of the second cylinder bank each carry out a second decompression stroke within the working cycles of the cylinders, such that the cylinders of the second cylinder bank each carry out a second decompression cycle. As part of these second decompression strokes, gas compressed by means of the pistons in the cylinders of the second cylinder bank is released from the cylinders of the second cylinder bank via the outlet channels of the cylinders within the work cycles of the cylinders of the second cylinder bank without compression energy stored in this gas being able to be used to move the pistons from the upper dead center into the lower dead center. In the engine braking operation, all outlet valves of all cylinders of the second cylinder bank implement a substantially smaller stroke than in the normal operation, i.e., in the fired operation of the internal combustion engine 10.

The second cylinder bank is thus in the first engine braking mode in the conventional engine braking operation and generates an engine braking power as usual. All cylinders of the first cylinder bank are filled with fresh gas during the suction stroke. Since the elevation of the inlet valves is set to “late”, this begins somewhat later than usual and ends somewhat later than usual, such that a part of the filling is again pushed back into a charging plenum chamber at the start of the compression stroke. Then, the air is compressed in the compression stroke, for which power is received. In the subsequent work stroke, the cylinder pressure is again converted into rotational energy, wherein not all energy is regained as a result of blow-by and heat losses, but rather a part contributes to the engine braking power as thermodynamic dissipation power. In the subsequent extending stroke, the air is compressed again, since the outlet valves of the first cylinder hank do not open. At the start of the subsequent suction stroke, a very high pressure is thus prevalent in the respective cylinder of the first cylinder bank. This pressure is again converted into rotational energy until the point is reached at which the respective inlet valve of the first cylinder bank opens. Now the air can escape on the inlet side. In doing so, as a result of the rapid pressure drop, on the one hand an anti-clockwise cycle emerges. Engine braking power is generated on the cylinders of the first cylinder bank. On the other hand, the highly compressed air which can have up to 20 bar, in particular, serves to additionally load the cylinder of the second cylinder bank, which is at the end of its suction stroke at this time point, with gas. A further effect is that, by no mass throughout being generated on the cylinders of the first cylinder bank, the air is thus only exchanged with the inlet side, yet not with the outlet side, and thus a turbocharger is operated in a different region of its characteristic map. While the turbocharger is usually operated with a 3-cylinder engine braking operation in the lower right region, the operating point now slips to the left towards better degrees of efficiency, such that the system is supplied with a higher charging pressure than in the usual 3-cylinder operation. All this leads to a higher engine braking power being able to be generated than in the conventional 3-cylinder operation. Thus, a further engine braking torque strip emerges that settles between the strips in the usual 3-cylinder engine braking operation and in the 6-cylinder engine braking operation. Depending on the further regulating possibilities, such as using an AGR valve of an exhaust gas recirculation system, for example, the gap between the two strips of the 3-cylinder engine braking operation and the 6-cylinder engine braking operation can thus be closed.

Alternatively to this, in the first engine braking mode of the method, all outlet valves of all cylinders of the second cylinder bank are opened in the region of an upper dead center and then closed in order to respectively release gas compressed in the cylinders of the second cylinder bank from the cylinders of the second cylinder bank respectively by means of pistons guided in the cylinders of the second cylinder bank. FIG. 2 shows the alternative course of an outlet stroke 18′. Here, the outlet valves of the second cylinder bank in the outlet stroke 18′ open only once in the region of the first opening time point AO2 of the outlet valve stroke 18 in an opening time point AO2″ and then close at about 90° of crank angle in a closing time point AS2″ before the second closing time point AS2′ of the outlet stroke 18. The outlet valves of the second cylinder bank are not opened for a second time and remain closed until the single opening in the region of the upper dead center at 720° of crank angle.

In a second engine braking mode of the method, all cylinders of the second cylinder bank are operated in a propulsion operation. Thus, on the second cylinder hank, in the second engine braking mode, the normal inlet and outlet valve elevations from a normal operation can be maintained. The first cylinder bank is operated corresponding to the first engine braking mode. On the first cylinder bank, an outlet stroke of all outlet valves is thus switched off, and the inlet camshaft is rotated until all inlet valves of the first cylinder open to a still permissible pressure. As in the first engine braking mode, on the first cylinder bank, an anti-clockwise cycle emerges by releasing cylinder pressure onto the inlet side. Thus, engine braking power is generated. This is lower than the engine braking power normally provided with three cylinders and is thus suitable for closing the gap between a propulsion operation and an engine braking operation with three cylinders. The mass throughput necessary for removing the generated heat is expressed on the cylinders of the second cylinder bank.

In a third engine braking mode of the method, an outlet stroke of all outlet valves of all cylinders of the first and the second cylinder bank of the internal combustion engine is switched off, and an opening time point EO1, EO2′ of all inlet valves of all cylinders of the first and the second cylinder bank are adjusted to “late”. Accordingly, in the third engine braking mode, all cylinders of the internal combustion engine 10 are operated according to the first cylinder bank in the first engine braking mode. Thus, with all cylinders, the outlet valve stroke is switched off and the inlet camshaft is thus rotated until the inlet valves open to a still permissible pressure. Thus, a decompression event emerges towards the inlet side, in turn thus generating engine braking power. However, no mass throughout is generated by the internal combustion engine 10, whereby the third engine braking mode can only be maintained in the short term. It is nevertheless suitable fur expressing a gentle transition from the propulsion operation into one of the engine braking modes or into the 3- or 6-cykinder engine braking operation or vice versa, which can be useful for reasons of comfort, for example for buses.

### LIST OF REFERENCE CHARACTERS

10 Internal combustion engine

11 Motor vehicle

12 Outlet stroke

13 Control and regulating unit

14 Drive wheels

15 Multi-stage transmission

16 Inlet stroke

17 Inlet stroke

18 Outlet stroke

19 X-axis

20 Y-axis

AO2 Opening time point

AO2′ Opening time point

AS2 Closing time point

AS2′ Closing time point

EO1 Opening time point

EO2′ Opening time point

1.-6. (canceled)

7. A method for operating an internal combustion engine of a motor vehicle in an engine braking operation, comprising the steps of:
in a first engine braking mode, switching off an outlet stroke of all outlet valves of all cylinders of a first cylinder bank;
adjusting an opening time point of all inlet valves of all cylinders of the first cylinder bank to late;
in the first engine braking mode, closing all outlet valves of all cylinders of a second cylinder bank for a first time, then opening all outlet valves of all cylinders of the second cylinder bank for a first time, then closing all outlet valves of all cylinders of the second cylinder bank for a second time, and then opening all outlet valves of all cylinders of the second cylinder bank for a second time, in order to release compressed gas respectively from all cylinders of the second cylinder bank by respective pistons guided in all cylinders of the second cylinder bank; and
in the first engine braking mode, adjusting an opening time point of all inlet valves of all cylinders of the second cylinder bank to late.

8. The method according to claim 7, wherein, in a second engine braking mode, operating all cylinders of the second cylinder bank in a propulsion operation.

9. The method according to claim 8, wherein, in a third engine braking mode:
switching off the outlet stroke of all outlet valves of all cylinders of the first cylinder bank and an outlet stroke of all outlet valves of all cylinders of the second cylinder bank; and
adjusting an opening time point of all inlet valves of all cylinders of the first and the second cylinder bank to late.

10. A method for operating an internal combustion engine of a motor vehicle in an engine braking operation, comprising the steps
in a first engine braking mode, switching off an outlet stroke of all outlet valves of all cylinders of a first cylinder bank;
adjusting an opening time point of all inlet valves of all cylinders of the first cylinder bank to late:
in the first engine braking mode, opening all outlet valves of all cylinders of a second cylinder bank in a region of an upper dead center and then closing all outlet valves of all cylinders of the second cylinder bank, in order to release compressed gas respectively from all cylinders of the second cylinder bank by respective pistons guided in all cylinders of the second cylinder bank; and
in the first engine braking mode, adjusting an opening time point of all inlet valves of all cylinders of the second cylinder bank to late.

11. The method according to claim 10, wherein, in a second engine braking mode, operating all cylinders of the second cylinder bank in a propulsion operation.

12. The method according to claim 11, wherein, in a third engine braking mode:
switching off the outlet stroke of all outlet valves of all cylinders of the first cylinder bank and an outlet stroke of all outlet valves of all cylinders of the second cylinder bank; and
adjusting an opening time point of all inlet valves of all cylinders of the first and the second cylinder bank to late.

13. A motor vehicle, comprising:
an internal combustion engine; and
a control and/or regulating unit configured to perform the method according to claim 7 or claim 10.

14. The motor vehicle according to claim 13, wherein the control and/or regulating unit is configured to perform a method for control of a camshaft actuator and/or outlet valves of the internal combustion engine.
